(19) United States
(12) Patent Application Publication
(10) Pub. No.: US 2026/0119205 A1
(43) Pub. Date: Apr. 30, 2026

(54) SYSTEMS AND METHODS FOR GENERATING RECOMMENDATIONS FOR RECONFIGURING USER INTERFACES

(71) Applicant: Dell Products L.P., Round Rock, TX (US)

(72) Inventors: MING QIAN, Allston, MA (US); HANNA YEHUDA, Acton, MA (US); HANNAH CLAIRE HYATT, Seattle, WA (US); JOANNE HUBBARD, Concord, MA (US)

(21) Appl. No.: 18/931,634

(22) Filed: Oct. 30, 2024

(51) Int. Cl. G06F 9/451; G06F 3/01

(52) U.S. Cl. CPC G06F 9/451; G06F 3/013

(57) ABSTRACT

Methods and systems for managing operation of a data processing system are disclosed. To manage operation of the data processing system, a user flow data set for an instance of a performance of a monitored workflow for simplification may be identified. The user flow data set for the monitored workflow may be analyzed in order to obtain at least one recommendation for modifying an instance of a user interface used by the user during performance of the monitored workflow. The recommendation may be based on identification of inefficiencies in the user interface during performance of the monitored workflow and used to seamlessly implement updates to operation of the user interface used by the data processing system. By doing so, modifications to improve and optimize the user interface may be implemented and thereby improving the likelihood that desired computer implemented services may provided to a user of the data processing system.

### FIELD

Embodiments disclosed herein relate generally to managing a data processing system. More particularly, embodiments disclosed herein relate to systems and methods for managing operations of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2C show diagrams illustrating data flows in accordance with an embodiment.

FIGS. 2D-2G show diagrams illustrating an example of a representation of interactions between a user and user interface elements presented to the user by the data processing system.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware components (e.g., processors, memory modules, storage devices, communication device, etc.). The hardware components may support execution of any number and types of application (e.g., software components).

To provide the computer implemented services, user feedback may need to be obtained. For example, a user may need provide user input by interacting with the data processing system via a graphical user interface (e.g., screen, display, etc.). To facilitate the interaction (e.g., between the user and the data processing system), various user interface elements (e.g., dashboards, menus and other widgets) may need to be displayed to the user via the graphical user interface. By displaying the user interface elements, the user may activate various functions of software components by navigating the user interface elements (e.g., widget functions and other components using graphical user interfaces).

However, if the user is unable to navigate the graphical user interfaces in a manner required to activate the function of the software components (e.g., intended use of the software components) then the function may not be activated and therefore, computer implemented services may not be provided and/or provided in an effective manner. For example, For example, the user may select certain widgets (e.g., shown on a display hosted by the data processing system) as part of performing a task (e.g., one of the functions of the software). If the user is unable to locate the widgets (e.g., due to poor design and/or presentation of the widgets) and/or if the selection of widgets necessary to complete the task is complicated, the user may be deterred from engaging in further interactions with the user interface, and therefore, decrease the likelihood of the completion of the task and the desired computer implemented services may not be provided.

To understand the interactions between a user and user interface elements, a recording of content displayed on a graphical user interface (e.g., screen, monitor, etc.) may be obtained and used to identify challenges faced by a user when interacting with user interface elements.

However, the content (e.g., data) shown on the graphical user interface may include sensitive data and as such, obtaining a copy (e.g., recording) of the content may violate privacy considerations of the user and/or require obtaining additional approval from the user in order to adhere to privacy regulations.

Even if lack of access to data (e.g., screen recording data) was resolved, the system may lack sufficient resources and/or consume large quantities of limited resources in order to analyze the data to identify recommendations for modifying user interfaces based on challenges, issues, etc. with the user interfaces (and/or interface elements within the user interfaces) used by a user during performance of a workflow. Some of the challenges and/or issues impacting the usability and/or operation of user interfaces by a user of the data processing system may arise from inefficiencies due to complex, suboptimal designs of user interfaces and/or interface elements, for example.

Thus, to manage operation of a data processing system and reduce inefficiencies during performance of a monitored workflow, automated recommendations for reconfiguring user interfaces to improve user interface utility and enhance workflow automation may be provided. The automated recommendations may be obtained by analyzing user interactions with user interface and/or interface elements within each of the user interfaces used by a user during performance of a monitored workflow. The user interactions during performance of a monitored workflow may be represented by a discretized textual representation stored in a user flow data set. The user flow data set may be based on eye tracking data of a user and user input by the user during the instance of performing the monitored workflow.

An automated analysis of the discretized textual representation may be performed to identify redundant interfaces, suboptimal positioned interface elements within a user interface, and/or other elements of the user interface used by a user during performance of a monitored workflow. The recommendations may be generated to optimize the spatial arrangement of interface elements within a user interface (e.g., used by a user during performance of the monitored workflow), removal redundant/unnecessary user interfaces, and simplify the monitored workflow by improving the logical flow between tasks. By doing so, the overall performance of the data processing system may be improved and the likelihood of providing the desired computer implemented services may be increased.

In an embodiment, a method for managing operation of a data processing system is provided. The method may include: identifying a user flow data set for an instance of a performance of a monitored workflow for simplification, the user flow data set being based on eye tracking of a user and user input by the use during the instance of the performance of the monitored workflow; obtaining at least one simplification recommendation for modifying an instance of a user interface used by the user during the instance of the performance of the monitored workflow through automated analysis of a discretized textual representation of the instance of the performance stored in the user flow data set; updating, based at least in part on the at least one simplification recommendation, operation of the instance of the user interface used by the data processing system to obtain an updated data processing system; and providing computer implemented services using the updated data processing system.

The user flow data set may be selected from an ordering of user flow data sets for a plurality of instances of performance of the monitored workflow, and the selected user flow data set being the highest ranked user flow data set of ranked user flow data sets.

The ordering of the user flow data sets may be obtained by: for each user flow data set of the user flow data sets: obtaining, for each user flow data set of the user flow data sets, the metadata, the metadata comprising at least one quantification usable to order the user flow data sets; estimating a user time cost based on a portion of the metadata corresponding to the respective user flow data set of the user flow data sets; and ordering the user flow data sets based on the corresponding user time costs.

Obtaining the metadata may include: for each user flow data set of the user flow data sets: counting a number of interactions performed to complete the corresponding instance of performance of the monitored workflow to obtain an interaction count; for each of the number of interactions: estimating a transition cost for transitioning between two of the number of interactions; identifying whether the respective interaction of the number of interactions lead to a desired outcome for the user; and identifying a type of the respective interaction of the number of interactions.

Obtaining the at least one simplification recommendation may include: identifying, using the discretized textual representation of the instance of the performance stored in the user flow data set, a plurality of user interfaces used by the user during the instance of the performance; identifying, using the discretized textual representation of the instance of the performance stored in the user flow data set, numbers of uses of interface elements in each of the plurality of user interfaces by the user during the instance of the performance; comparing the number of uses and the plurality of user interfaces to criteria to identify at least one of the plurality of user interfaces for removal from future instances of the performance; and obtaining the at least one simplification recommendation based on the at least one of the plurality of user interfaces for removal from the future instances of the performance.

The criteria may include a minimum number of uses threshold that discriminates the at least one of the plurality of user interfaces for removal.

Obtaining the at least one simplification recommendation may include: selecting a portion of the interface elements based on the at least one of the plurality of user interfaces; and generating a recommendation to move the selected portion of the interface elements from the at least one of the plurality of user interfaces to other user interfaces used by the user during future instances of the performance.

The criteria may specify a maximum number of user interfaces that are to be used in future instances of the performance, and the at least one of the plurality of user interfaces is selected due to the criteria not being met.

Obtaining the at least one simplification recommendation may include: identifying, using the discretized textual representation of the instance of the performance stored in the user flow data set, interface elements in each user interface of a plurality of user interfaces used by the user during the instance of the performance; identifying, using the discretized textual representation of the instance of the performance stored in the user flow data set, spatial distances between the interface elements in each of the plurality of user interfaces during the instance of the performance; comparing the spatial distances to criteria to identify at least one of the interface elements for reordering within a user interface of the user interfaces for future instances of the performance; and obtaining the at least one simplification recommendation based on the at least one of the interface elements for reordering within the user interface for the future instances of the performance.

The criteria may include a maximum distance threshold that discriminates the at least one of the interface elements for reordering within the user interface.

The criteria may specify a minimum spatial distance between interface elements in future instances of the performance, and the at least one of the interface elements is selected due to the criteria not being met.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

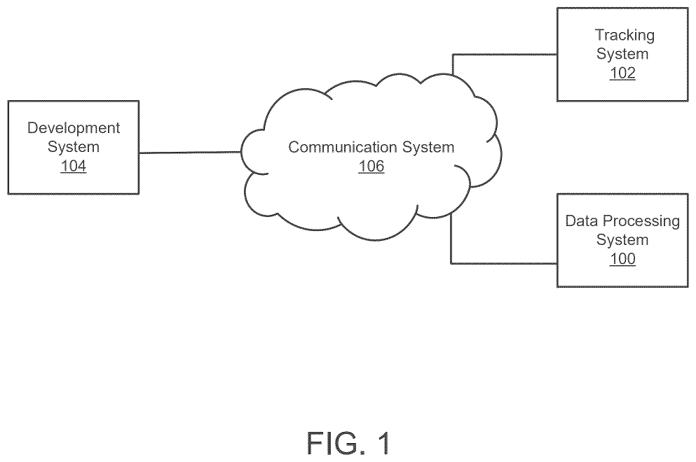

Turning to FIG. 1, a block diagram illustrating a system in accordance with an embodiment is shown. The system shown in FIG. 1 may provide computer-implemented services. The computer-implemented services may include data management services, data storage services, data access and control services, database services, and/or any other type of service that may be implemented with a computing device.

The system may include data processing system 100. Data processing system 100 may provide all, or a portion, of the computer implemented services. To provide the computer implemented services, workloads may be performed by various components of data processing system 100. To perform the workloads, user input may need to be obtained. The user input may include any type and quantity of information.

To obtain user input, a user may interact with a graphical user interface hosted by data processing system 100. For example, a user may perform physical actions such as, for example, pressing buttons on a keyboard, moving structures (e.g., such as a computer mouse), etc. To facilitate the interaction between a user and data processing system 100, various user interface elements may be presented to the user via the graphical user interface of data processing system 100. For example, the user interface elements may include menus, widgets, and/or other types of user interface elements shown on a display of data processing system 100.

A user may need to navigate the user interface elements (e.g., widgets, menus, etc.) and/or other elements presented on the graphical user interface of data processing system 100 in order to activate various functions of software components of the data processing system and thereby perform the desired workflow. However, if the user is unable to navigate the graphical user interfaces in a manner required to activate the function (e.g., of the software components), the function may not be activated and therefore, the computer implemented services may not be provided and/or provided in an efficient manner.

A user's interactions with the user interface elements (e.g., presented by data processing system 100) may be tracked in order to identify potential issues, challenges, and/or other hinderances that the user may experience when navigating the graphical user interface to complete various workflows. To do so, data processing system 100 may host hardware and/or software components that obtain signals and/or data representing eye gaze of a user (e.g., operating data processing system 100). For example, a camera lens hosted by data processing system 100 may record locations of where the user (e.g., while operating data processing system 100) is visually looking on the display of data processing system 100. The recorded locations of where the user was visually looking at may be represented by pixel range (e.g., range of pixels displayed by data processing system 100). For example, a camera lens hosted by data processing system 100 may record locations of where the user (e.g., while operating data processing system 100) is visually looking on the display of data processing system 100.

A video of the screen (e.g., information displayed to the user at the time of operation) may be recorded and used, in addition to the visual tracking data, to identify the user's interactions with the user interface elements. However, video recordings of information displayed to the user may present a problem regarding violation of privacy regulations and/or additional challenge to obtain authorization from the user to record the information prior to execution. For example, obtaining approval from the user's to record content displayed by data processing system 100 may present a challenge if the content includes sensitive data such as privileged and/or proprietary information and unauthorized disclosure of such data may be disadvantageous to the user.

Even if authorization to obtain a screen recording of the content displayed to a user was granted, the screen recording data may implicate privacy considerations and/or consume large quantities of storage space (e.g., of storage devices hosted by data processing system 100) as well as require a subject matter expert to review the screen recording data to identify potential challenges, issues, errors, etc. with the user interface elements in order to generate modifications to the operation of the data processing system 100 to improve usability of data processing system 100.

For example, screen recording data along with eye tracking data may consume large quantities of storage space in addition to consuming large amounts of processing power (e.g., processor capabilities) in order to be stored and/or analyzed for identification of design challenges and/or modifications to various graphical user interfaces used in performance of various workflows. If the challenges impacting user's interactions with the graphical user interfaces are not identified, the workflows may not be performed in a desirable manner and then the system may fail to provide the desired computer implemented services. For example, complex user interface designs may reduce a user's ability to easily perform a workflow which may cause a delay in performing the workflow leading to the resulting services (e.g., outcome of the workflow) not being provided in a timely manner.

For example, in multi-step workflows involving interaction with several user interfaces by a user, a lack of cohesion between interface elements (e.g., widgets, buttons, input fields, etc.) may lead to repeated actions (e.g., performed by the user) and/or switching between user interfaces (e.g., screens, view blocks, etc.) unnecessarily and, thereby increasing the likelihood of user fatigue and restricting workflow automation.

In general, embodiments disclosed herein may provide methods, systems, and/or devices for managing operation of a data processing system. To manage operation of the data processing system, a system in accordance with an embodiment may provide an automated framework for recommendations to simplify workflows. The automated recommendations for reconfiguring user interfaces used by a user during performance of a monitored workflow may be provided by analyzing a textual representation of a set of interactions between a user and user interface elements during an instance of the performance of the monitored workflow (e.g., a user flow data set). By analyzing the textual representation stored in the user flow data set (e.g., selected for simplification), inefficiencies in the monitored workflow may be identified and used to generate recommendations for reconfiguring the user interfaces (e.g., used by the user during performance of the monitored workflow) to reduce the inefficiencies.

The automated recommendations may target improving the overall flow (e.g., of performing the monitored workflow), reducing the number of steps required to complete tasks (necessary to complete the monitored workflow), and enhancing automation by eliminating unnecessary or redundant actions. By doing so, the automated recommendations may be leveraged to update and optimize the user interface (e.g., design of the user interface, interface elements, etc.), thereby streamlining workflows, improving the likelihood of a user's experience (e.g., operating the data processing system), and/or increasing the likelihood of the data processing system providing the desirable computer implemented services to the user.

To provide the above noted functionality, the system of FIG. 1 may include data processing system 100, tracking system 102, development system 104, and communication system 106. Data processing system 100, tracking system 102, development system 104, and/or any other type of devices not shown in FIG. 1 may perform all, or a portion of the computer-implemented services independently and/or cooperatively. Each of these components is discussed below.

Data processing system 100 may (i) facilitate collection of data, (ii) identify the type of data collected, (iii) provide the data to external entities (e.g., tracking system 102, development system 104, etc.), (iv) receive information including instructions for updating operation of the data processing system, and/or (v) otherwise facilitate collection, transmission, and/or management of data regarding interactions between user interface elements and a user (operating data processing system 100).

Data processing system 100 may include hardware components usable to provide the computer implemented services. For example, data processing system 100 may be implemented using a computing device such as a laptop computer, desktop computer, portable computer, and/or other types of computing devices. Data processing system 100 may include devices which may collect, store, and/or manage data, various types of sensors connected to a computer that collects information (e.g., camera, microphone, etc.), and/or any other type of data collection devices.

Data processing system 100 may host software that may use user input to provide the computer implemented services. For example, the software may provide user input fields and/or other elements through which the user may provide information to manage and/or use the computer implemented services provided by data processing system 100. For example, the user may physically interact with data processing system 100 (and/or component thereof), thereby allowing signals and/or data to include information regarding the physical actions of the user.

For example, if a user actuates a moveable structure (e.g., buttons) of a human interface device (of data processing system 100), data processing system 100 may track the actuation of the button and provide signals and/or data reflecting the actuation (e.g., the user input).

To facilitate computer implemented services, tracking system 102 may (i) identify a user flow data set (for an instance of a performance of a monitored workflow) for simplification, (ii) obtain at least one simplification recommendation for modifying a user interface used by the user during performance of the monitored workflow through automated analysis of a discretized textual representation stored in the user flow data set, (iii) update operation of the user interface (during performance of the monitored workflow) used by the data processing system to obtain an updated data processing system using at least in part (the at least one) simplification recommendation, and/or (iv) otherwise facilitate collection, transmission, and/or analysis of data usable for tracking the interactions between a user and user interfaces (and/or interface elements within each of the user interfaces) during performance of the monitored workflow.

The user flow data set may be identified by (i) obtaining user flow data sets for a plurality of instances of performance of a monitored workflow, (ii) obtaining metadata for each user flow data set, the metadata including at least one quantification usable to order the user flow data sets, and/or (iii) obtaining an ordering of the user flow data sets using the metadata and the user flow data sets.

To obtain user flow data sets for instance of a monitored workflow being performed, tracking system 102 may (i) obtain predefined parameters for various workflows to monitor (for data processing system 100), (ii) obtain data (eye tracking data, user input, etc.) from data processing system 100, (iii) identify occurrences of a monitored workflow performed by the user of data processing system 100, (iv) based on the identification and during performance of the monitored workflow, infer the attention of the user on user interface elements (presented to the user by data processing system 100) based on the eye tracking data and/or user input, (v) generate, based on the inferred attention of the user, a representation of the interactions between the user and the user interface elements that resulted in completion of the monitored workflow, (vi) provide the representation of the interactions to development system 104, and/or (vii) otherwise facilitate collection, transmission, and/or analysis of data usable for tracking the interactions between a user and user interface elements (of data processing system 100).

Development system 104 may include any number and/or type of device (e.g., data processing system, management systems, storage devices, user devices, etc.) that may provide computer implemented services, such as development services. To perform its functionality, development system 104 may (i) obtain user flow data (e.g., based on eye tracking data, user input, representation of interactions between a user and user interface elements) from tracking system 102, (ii) manage and/or provide access to the use flow data (e.g., to an authorized subject matter expert), (iii) provide updates (e.g., for the user interfaces) for operation of data processing system 100, and/or (iv) otherwise participate in managing operation of data processing system 100.

Thus, the operation of data processing system 100 may be managed according to interactions between a user and user interface elements (presented by data processing system 100) resulting in completion of a workflow. The interactions may be based on inferred attention of the user using eye tracking data and user input during performance of the workflow. The tracked interactions for various workflows may be analyzed to identify a best possible set of interactions during performance of respective workflows.

Based on the identified set of interactions during an instance of the performance of a workflow, a recommendation to simplify operation of the user interfaces used by the user during performance of the workflow may be obtained through automated analysis of the interactions. The recommendation may be utilized to update and optimize the user interface (and/or user interface elements) to reduce unnecessary, repetitive steps (e.g., performed by the user) to complete the workflows. By doing so, a system in accordance with embodiment disclosed herein may provide data processing systems having, for example, (i) improved user experiences by minimizing unnecessary steps and/or slowdowns in completion of a workflow, and/or (ii) improved computing resource availability for desired computer implemented services.

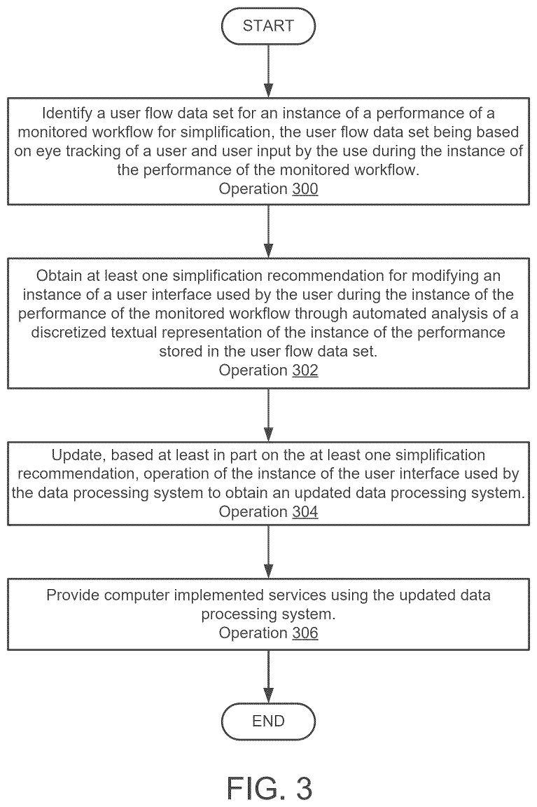

When providing its functionality, data processing system 100, tracking system 102, and/or development system 104 may perform all, or a portion, of the method and/or actions shown in FIG. 3.

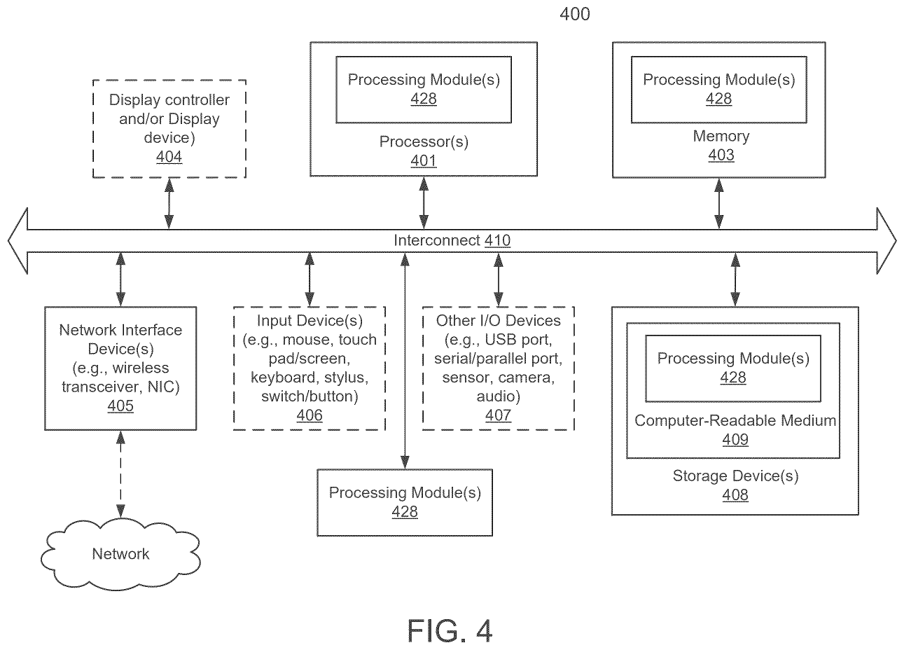

Any of (and/or components thereof) data processing system 100, tracking system 102, and/or development system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

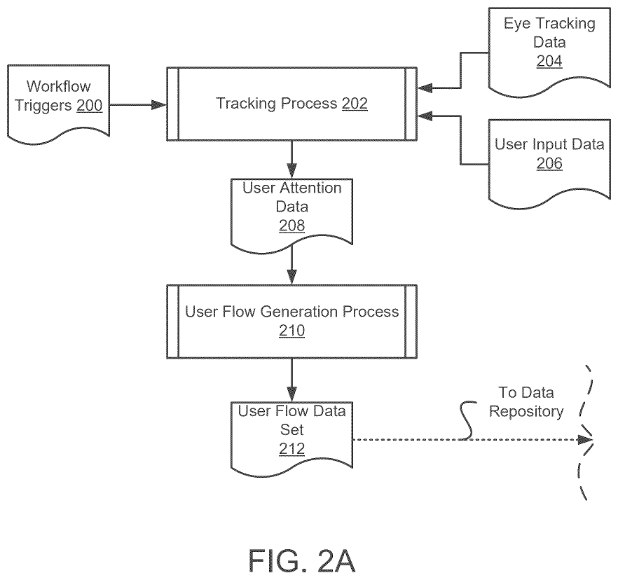

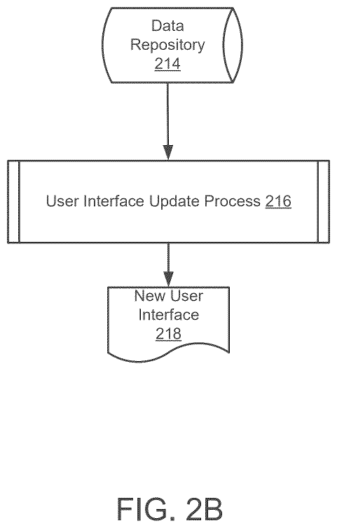

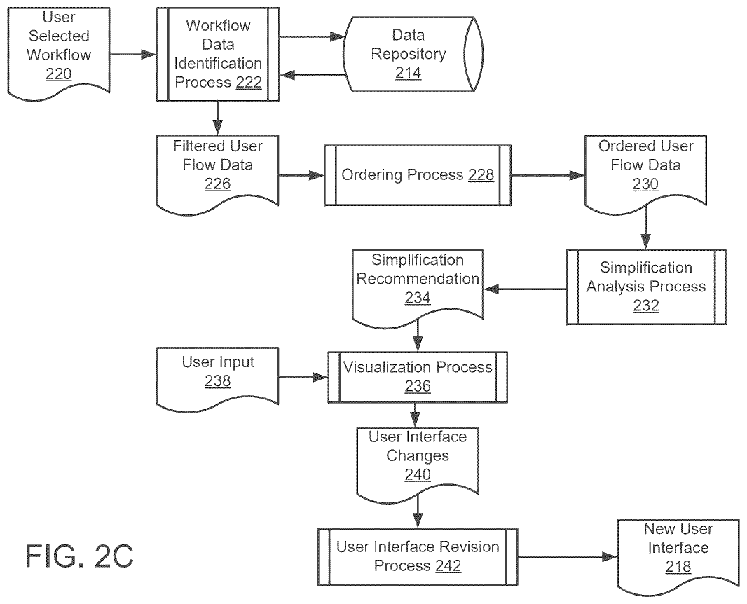

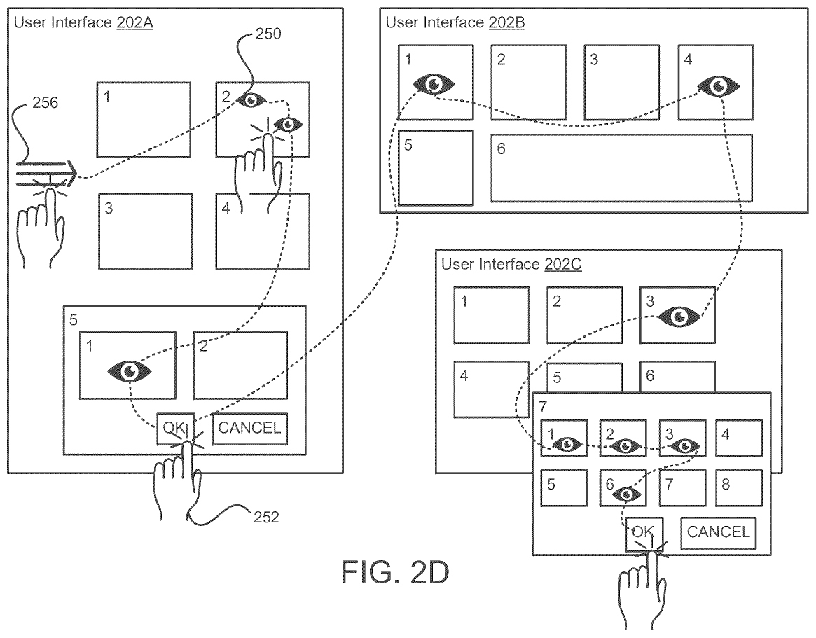

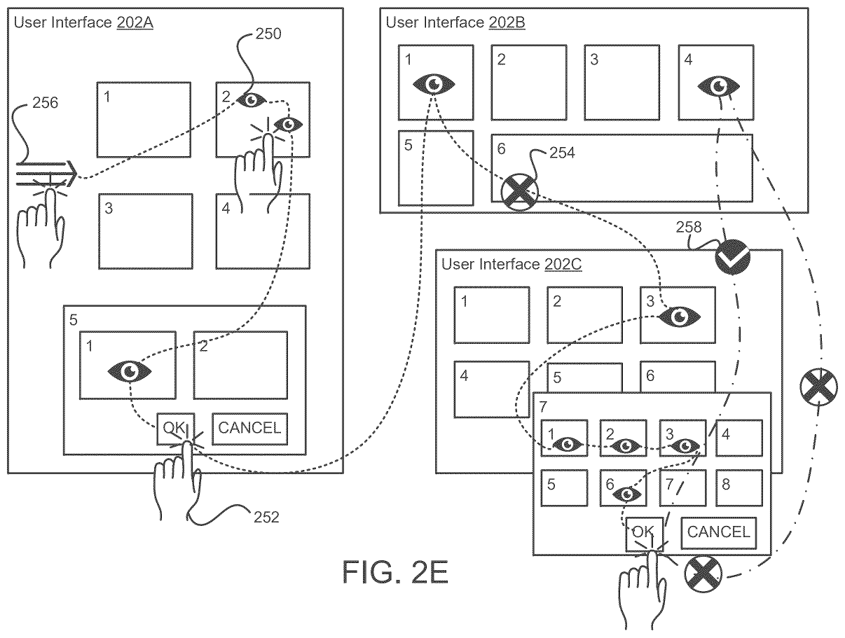

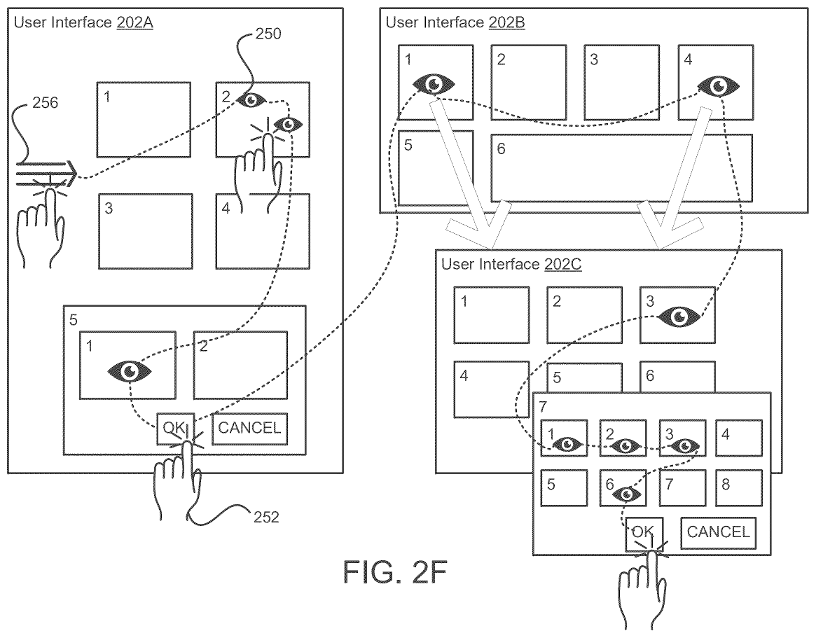

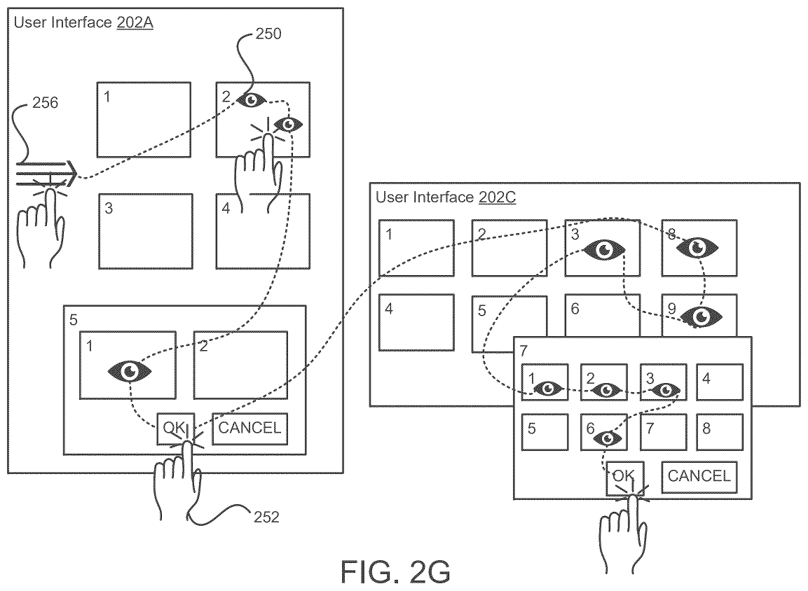

To further clarify embodiments disclosed herein, diagrams illustrating data flows implemented by a system over time in accordance with an embodiment are shown in FIGS. 2A-2C. In FIGS. 2A-2C, a first set of shapes (e.g., 204, 208) is used to represent data structures, and a second set of shapes (e.g., 202, 210) is used to represent processes performed using data, and a third set of shapes (e.g., 214) is used to represent large scale data structures such as databases.

Turning to FIG. 2A, a first data flow diagram illustrating data flows, data processing, and/or other operations that may be performed by the system of FIG. 1 in accordance with an embodiment is shown. The first data flow diagram may illustrate data used in and data processing performed in generating a representation of interactions between a user and user interface elements of a data processing system.

To generate a representation of the interactions between a user and user interface elements, eye tracking data 204 and user input data 206 may be obtained over a period of time (e.g., from data processing system 100). Eye tracking data 204 may include any type and/or quantity of data relating to a user's eye gaze on user interface elements (e.g., presented by the data processing system 100). For example, eye tracking data 204 may include information about where the user's gaze is focused on the screen (e.g., of data processing system 100).

User input data 206 may include any type of data representing physical actions such as, for example, pressing buttons, moving structures, etc. The physical actions of the user (e.g., operating data processing system 100) may be sensed by various devices and the sensing may be interpreted (e.g., translated) into the user input (e.g., user input data). For example, user input data 206 may include a user operating a keyboard, a mouse, and/or any other auxiliary device capable of receiving input signals from the user.

Tracking process 202 may collect and analyze eye tracking data 204 and user input data 206 during performance of various monitored workflows. Each monitored workflow (e.g., performed by a user of data processing system 100) may represent a user orientated task that has a defined start, a defined end, and that, when performed, results in a predetermined outcome.

To initiate tracking process 202, workflow triggers 200 may be identified. Workflow triggers 200 may include predefined parameters for monitored workflows, and may include trigger conditions for each monitored workflow indicating initiation and/or completion of the respective monitored workflow.

User input data 206 and/or eye tracking data 204 may be compared to workflow triggers 200 (trigger conditions associated with monitored workflows) to identify when any of the monitored workflows start. For example, a trigger condition for a monitored workflow may include identifying an instance of input signals received from selecting a widget (e.g., menu icon) via operation of a graphical user interface by a user. By identifying the selection of the widget (e.g., workflow trigger), the monitored workflow associated with the selection of the widget may be identified and thereby, initiate tracking process 202.

Once the occurrence of the monitored workflow has been identified, tracking process 202 may be performed to obtain user attention data 208 during performance of the monitored workflow. The attention of the user may be inferred based on eye tracking data 204, and/or user input 206. Tracking process 202 may include collecting and/or analyzing eye tracking data 204 and user input data 206 during performance of the monitored workflow.

Eye tracking data 204 may be used to identify that a dwell of a gaze of the user on at least one of the user interface elements has exceeded a duration of time (e.g., predefined period of time set by a subject matter expert) and conclude that the attention of the user is focused on at least one of the user interface elements for the duration of time.

User input data 206 may be used to identify that the user has interacted with at least one of the user interface elements and conclude that the attention of the user is focused on the user interface elements for the duration of time (e.g., during which the user interacted with the user interface elements).

User attention data 208 may include any type and quantity of data representing inferred attention of the user, and may include a description of the user interface element for the interaction. For example, the user's attention on user interface elements (e.g., screens, view-blocks presented on different screens, etc.) may be inferred based on location of the user's eye gaze (e.g., from eye tracking data 204) and/or interactions of the user with the user interface elements (e.g., from user input data 206).

User attention data 208 for each monitored workflow may be obtained until the trigger condition indicating completion of the respective monitored workflow has been met. For example, for a monitored workflow, the trigger condition indicating completion of the monitored workflow may include terminating operation of a program, and if user input data 206 indicates selection of a closing out the program (e.g., via left click of a button on a computer mouse by a user) displayed via the graphical user interface, the trigger condition may be met and thereby conclude obtaining user attention data (208) for the monitored workflow.

User attention data 208 may be used in performing user flow generation process 210 to generate a representation of the interactions. During user flow generation process 210, the inferred attention of the user and interaction data may be processed to generate a user flow data set (e.g., user flow data set 212). A first string of data representing the user interface element and a second string of data representing the interaction (e.g., based on the inferred attention of the user during performance of the monitored workflow) may be concatenated into a third string (or a single data structure) representing a temporal order in which the interactions occurred.

To do so, for each user interface element (e.g., identified via user attention data 208), an interaction of the user with the user interface element may be identified and for each identified interaction, a label indicating the outcome of the interaction may be generated. For example, user input data 206 may be analyzed to append the status of the interaction (e.g., success or failure) between the user and the user interface element.

If the interaction between the user and the user interface element (e.g., program presented to the user via the graphical user interface) is accepted (e.g., a click on a button where the program accepts the user input and activates the next activity in the workflow), the interaction may be identified as a success. Conversely, if the interaction between the user and the user interface element is rejected (e.g., a click on the button where the program denies the user input and does not activate the next activity in the workflow), the interaction may be identified as a failure.

The interactions between the user and the user interface elements may provide data necessary to identify failures that occur around attempts to perform workflows. The interactions that are indicated as failures may provide guidance for eliminating and/or reducing the likelihood of potential failures to occur in the future.

The generated user flow data representing the interactions between the user and the user interface elements that resulted in completion of the monitored workflow is stored in a dataset (e.g., user flow data set 212). User flow data set 212 may be provided to any type of data repository for storage (e.g., accessible by tracking system 102, development system 104, etc.).

Thus, as shown in the example of FIG. 2A, a system in accordance with an embodiment may facilitate collection of tracking data (e.g., eye tracking data and user input) for a user interacting with user interface elements over a period of time, identifies user flows during the monitored workflows, and generates a representation of the user's interactions to further improve operation of the data processing system.

Turning to FIG. 2B, a second data flow diagram illustrating data flows, data processing, and/or other operations that may be performed by the system of FIG. 1 in accordance with an embodiment is shown. The second data flow diagram may illustrate data used in and data processing performed in utilizing data in preparation of obtaining a new user interface.

To utilize data in preparation of obtaining the new user interface, user flow data set 212 may be obtained and used in performance of various updating processes. User flow data set 212 may be stored in data repository 214 and accessible, for example, by development system 104. User flow data set 212 may include different types of user flow data sets obtained at different points in time by a tracking system (e.g., 102 shown in FIG. 1).

Based on a selected monitored workflow (e.g., by a user and/or administrator of data processing system 100), the associated user flow data set 212 may be obtained from data repository 214. The user flow data set for each performance of the selected monitored workflow may be utilized during performance of user interface update process 216 to determine modifications to the user interface to improve user experience and workflow efficiency. Refer to FIG. 2C for additional details regarding analyzation of user flow data and implementation of revisions to user interfaces.

As a result of performing user interface update process 216, a new user interface 218 may be obtained. New user interface 218 may include an updated user interface incorporating modifications and/or improvements to update operation data processing system 100 (e.g., as provided during user interface update process 216).

Thus, via the process illustrated in FIG. 2B, user flow data sets for a plurality of instances of performance of a monitored workflow may be used to update operation of a data processing system (e.g., update the user interface to obtain a new user interface).

Turning to FIG. 2C, a third data flow diagram illustrating data flows, data processing, and/or other operations that may be performed by the system of FIG. 1 in accordance with an embodiment is shown. The third data flow diagram may illustrate data used in and data processing performed during updating operation of a data processing system to obtain a new user interface. The flows may be used, for example, during user interface update process 216 (e.g., shown in FIG. 2B).

To obtain a new user interface (e.g., new user interface 218), selected monitored workflow 220 may be obtained. Selected monitored workflow 220 may include any type and quantity of workflows that may be monitored and used in managing operation of the data processing system. Selected monitored workflow 220 may include a description of a user orientated task with a defined start, a defined end and that, when performed, results in a predetermined outcome.

Selected monitored workflow 220 may be obtained via (i) receiving user input from a device (e.g., user operating development system 104), (ii) identifying a management event has occurred (e.g., period of time has elapsed, user interface operation error, and/or any other type trigger condition) corresponding to the monitored workflow. For example, a user interface designer and/or another subject matter expert may provide user input (e.g., via operation of development system 104) indicating selection of a monitored workflow for which analysis and/or modifications may be of interest. The monitored workflow may also be obtained, for example, via an automated process. For example, the monitored workflow may be selected based on a time schedule (e.g., defining a specific times and/or duration of times to elapse) and therefore, automatically initiating the selection of the monitored workflow.

Based on the selected monitored workflow, workflow data identification process 222 may be performed. During workflow data identification process 222, the selected monitored workflow may be used in querying data repository 214 to obtain relevant data related to the selected monitor workflow. For example, an identifier for the monitored workflow may be used to perform a look up to identify user flow data sets associated with the monitored workflow.

As a result of performing workflow data identification process 222, filtered user flow data 226 may be obtained. Filtered user flow data 226 may include any filtered data retrieved from data repository 214 that includes relevant information about the monitored workflow. Filtered user flow data 226 may include each recorded user flow data set for the monitored workflow. For example, for each performance of the monitored workflow (e.g., by users), a user flow data set (e.g., indicating a set of interactions initiated by a user during a corresponding instance of the performance of the monitored workflow) may be obtained. Filtered user flow data 226 may include any type and/or quantity of user flow data sets for each instance of the monitored workflow being performed.

Filtered user flow data 226 may be used in ordering process 228 to obtain an ordering of the user flow data sets for each instance of the monitored workflow being performed.

During ordering process 228, filtered user flow data 226 may be analyzed to obtain metadata usable to perform an ordering of the filtered user flow data to obtain ordered user flow data 230. For example, the user flow data sets may be used in any type of analyzation process to identify content (e.g., metadata) of the user flow data sets contributing to duration of time and probabilities of failures (e.g., undesired outcomes for each interaction) occurring.

For example, the user flow data sets may be analyzed to identify (i) an interaction count (e.g., number of interactions that the user performed to complete a corresponding instance of the monitored workflow), (ii) for each interaction, a transition cost for transitioning between two of the interactions, (iii) for each interaction, a type of the interaction, (iv) for each interaction, indication of whether the interaction lead to a desired outcome for the user, and/or other information usable to order the user flow data sets. To do so, the quantifications from filtered user flow data 226 may be compared to predetermined quantifications (e.g., defined by subject matter experts, automated analysis such as machine learning/data mining) associated with interactions performed in a prescribed manner.

Once obtained, the metadata (and/or a portion of the metadata) may be used to estimate a user time cost corresponding to the respective user flow data set. The user time cost may include an estimated duration of time for completing a corresponding user flow data set of the user flow data sets when performed in a prescribed manner by the user.

During ordering process 228, the metadata and the user flow data sets may be used in any type of optimization process to obtain an ordering of the user flow data sets. The optimization process may include using any type of function that weighs different quantifications (e.g., portions of the metadata) to obtain a weighted sum for each user flow data set. The weighted sum may be ascribed to each user flow data set and used to rank order the user flow data sets to identify the most optimal series of interactions (e.g., user flow data set with the lowest user time cost).

For example, ordering the user flow data sets may include comparing the user time costs for each user flow data sets to obtain a ranking order of the user flow data set with the lowest user time cost as the highest ranked user flow data set and the highest user time cost as the lowest ranked user flow data set.

The resulting ordered user flow data 230 from ordering process 228 may indicate (i) user flow data sets with the shortest duration of time for completing the monitored workflow and most likely to lead to a desired outcome for the user, (ii) user flow data sets with the longest duration of time for completing the monitored workflow and most likely to lead to undesired outcomes (e.g., failures) for the user, etc. Once obtained, ordered user flow data 230 may be used to identify a user flow data set for simplification (e.g., simplifying the monitored workflow).

Ordered user flow data 230 may be used to identify a user flow data set for simplification. For example, selection of the user flow data set may be based on the ordering of the user flow data sets (e.g., ordered user flow data 230) and identifying the highest rank ordered user flow data set of the ranked ordered user flow data sets.

Once the user flow data set is selected, simplification analysis process 232 may be performed to obtain recommendation(s) for simplifying performance of the monitored workflow. During simplification analysis process 232, a discretized textual representation of the instance of the performance of the monitored workflow may be subjected to any type of automated analysis process to obtain at least one simplification recommendation (e.g., simplification recommendation 234). The discretized textual representation may be stored in the user flow data set. The discretized textual representation may include, for example, the interactions with user interfaces (and/or interface elements within each user interface) by a user during an instance of performing the monitored workflow represented as a textual event and/or identifier. For example, the discretized textual representation may capture the sequence of actions (e.g., button clicks, eye gaze by the user, etc.) within each user interface during performance of the monitored workflow by a user.

For example, the discretized textual representation may include identification numbers for each of the user interfaces and/or interface elements of each of the user interfaces used by the user during performance of the monitored workflow.

During the automated analysis process, the discretized textual representation stored in the user flow data set may analyzed to identify underutilized user interfaces, interface elements that are suboptimally positioned within user interfaces, and/or any other elements potentially impacting efficiency and contributing to complexity of performing the monitored workflow.

Identifying underutilized user interfaces may include analyzing frequency in which user interfaces are used by a user during performance of the monitored workflow. For example, user interfaces used by a user during performance of the monitored workflow may be identified by analyzing the textual identifiers corresponding to different user interfaces of a data processing system (e.g., 100). Once the user interfaces are identified, the user's interaction with each interface element within the respective user interface may be identified. For example, the number of uses of interface elements in each of the user interfaces by a user during performance of the monitored workflow may be identified.

The frequency of use for each user interface and interface elements within each of the user interfaces may be utilized in any type of comparison process against predefined criteria to evaluate relevance of user interfaces to performance of the monitored workflow. The criteria may be established, for example, by a subject matter expert. The criteria may include a minimum threshold for the number of interactions required for a user interface to be considered essential. User interfaces that do not meet this threshold may be identified (e.g., selected, flagged, etc.) for potential removal from future iterations of the monitored workflow. By doing so, user interfaces infrequently used and/or not critical to the performance of the monitored workflow completion may be identified as candidates for removal.

Once (at least one of) the user interfaces for removal are identified, a portion of the interface elements (e.g., from the identified user interfaces) may be selected and a recommendation to move the selected portion of the interface elements from the user interface(s) identified for removal to other interface elements (e.g., used by the user during future performance of the monitored workflow). For example, the simplification recommendation may include consolidating interface elements from multiple user interfaces into a single, more effective user interface, and thereby, may reduce navigation and complexity during performance of the monitored workflow (e.g., by a user in the future).

Identifying interface elements that are suboptimally positioned within user interfaces may include analyzing interface elements in each user interface that a user interacts with during performance of the monitored workflow. For example, interface elements in each user interface used by the user during performance of the monitored workflow may be identified by analyzing textual identifiers corresponding to different distinct interface elements (e.g., buttons, text fields, links, etc.) within each user interface. Once the relevant interface elements are identified, the spatial distances between the interface elements in each user interface may be identified. The spatial distances may indicate a physical separation between interface elements on, for example, a display, screen, etc. and may be measured in pixels, sub-identifiers, and/or another unit of dimension usable by a graphical user interface (e.g., display, screen, etc.).

For example, each user interface and interface elements within each of the user interfaces may be assigned unique identifiers usable to differentiate the user interfaces and different portions of the user interfaces. For example, the discretized textual representation stored in the user flow data set may include an identifier for the user interface (e.g., “PowerFlex”) and a sub-identifier designating the portion of the user interface (e.g., “2”). The sub-identifiers for different portions of user interfaces may be based on a numbering scheme indicating a proximity of interface elements and/or portions of the user interface with other interface elements within a user interface. For example, “PowerFlex 1.0” may be in close proximity to “PowerFlex 2.0” but “PowerFlex 3.0” may be located further away from “PowerFlex 1.0” in comparison to “PowerFlex 2.0”. The numbering scheme may be used to identify the spatial distance between interface elements within a user interface.

Once identified, the spatial distances between interface elements with each user interface used by a user during performance of the monitored workflow may be utilized in any type of comparison process against predefine criteria to determine whether the distance between the two or more interface elements is too large and/or potentially affecting the efficiency of performing the monitored workflow by a user. For example, the criteria may include a maximum distance threshold that discriminates the interface elements for reordering within a user interface and may be established, for example, by a subject matter expert (e.g., user interface designer).

For example, if the maximum acceptable distance between interface elements used during the performance of the monitored workflow is defined as 150 pixels, and the distance between the interface element A (e.g., a “password” input field) and interface element B (e.g., a “submit” button) on the user interface (e.g., the login page) is 200 pixels, the interface elements may be identified (e.g., selected, flagged, etc.) as candidates for re-ordering (e.g., repositioning, relocating, etc.).

By identifying the interface elements that may be suboptimally positioned (e.g., within a user interface), a recommendation for rearranging the interface elements within a user interface may be made. Continuing the above described example, if the “submit” button on the login page is located too far from the “password input filed (e.g., exceeds the criteria threshold for maximum distance between interface elements), the simplification recommendation may include repositioning the “submit” button closer to the “password” field to reduce the time and effort required to complete the login process (e.g., completion of a monitored workflow).

The result of performing the above automated analysis is (at least one) simplification recommendation 234. Simplification recommendation 234 may include any quantity and/or type of recommendation for modifying an instance of a user interface used by the user during performance of the monitored workflow.

Simplification recommendation 234 may be used in visualization process 236 to generate a visual representation of the recommendations for modifying user interface and/or interface elements within each of the user interfaces interacted with by a user during performance of the monitored workflow.

Visualization process 236 may include generating a visual representation of the recommendations for eliminating unnecessary user interfaces, re-ordering interface elements within the user interfaces, and/or any other modifications to simplify the monitored workflow. The visual representation may be presented, for example, to a developer (via operation of development system 104) to illustrate design modifications to user interfaces to improve how users are interacting with user interface elements to complete various monitored workflows.

As part visualization process 236, user input 238 may be obtained, for example, by the developer and/or subject matter expert (e.g., via operation of development system 104 and/or graphical user interface hosted by development system 104). User input 2348 may include acceptance, adjustments, etc. to any of the recommended modifications to the user interface based on the visual representation of the interactions during performance of the monitored workflow. For example, user input 238 may include input on approval of proposed modifications, selection of addition changes to the user interface based on informed insights impacting the current user interface design (such as identified bottlenecks or inefficiencies), etc.

For example, the developer may identify that users are struggling to find and click on a specific button (e.g., the “submit” button is too small and buried at the bottom of a form) within a web application, which is essential for completing the selected workflow. User input 238 may include a recommendation to increase the size of the “submit” button, move the “submit” button to the top of the form, and/or any other modifications that may improve the user's ability to easily see the “submit” button.

User interface changes 240 may include instructions for modifications to the user interface. For example, user interface changes 240 may identify removal of (unnecessary) user interfaces, reordering of interface elements within the user interfaces, font size adjustments, widget reorganization, and/or any other modifications based at least in part on user input 238.

User interface revision process 242 may include implementing the user interface changes 240 to the user interface in order to obtain new user interface 218. For example, modifications to the user interface may be implemented within the application code associated with the respective programs. For example, implementation of the modifications may be performed by moving and/or resizing the “submit” button.

New user interface 218 may be obtained as a result of performing user interface revision process 238. New user interface 218 may be an updated user interface that provides an improved user interaction and user workflows, and overall efficiency and user experience.

Turning to FIG. 2D, a first example illustration of interactions between a user and user interface elements (presented by a data processing system) during performance of a monitored workflow.

In FIG. 2D, various symbols (e.g., 250, 252, 256, etc.) are used to indicate interactions with a user interface by a user. For example, the symbols may include a first illustrative symbol 252, which represents using a pointing device to click on a graphical user interface element. For example, a user may operate a computer mouse to navigate the pointing device (e.g., cursor) displayed on the user interface element and provide user input (e.g., user input data 206 shown in FIG. 2A).

As an additional example, a second illustrative symbol 250 may indicate a user's gaze has been directed at a portion of the user interface for a duration of time (e.g., exceeding a threshold) that we conclude that the user's attention is directed to that user interface element. In addition, a third illustrative symbol 256 may represent a menu icon (widget displayed on user interface 202A).

As described above, to identify when any of monitored workflows start, eye tracking data and/or user input may be compared to trigger conditions associated with monitored workflows. The user may select the menu icon (e.g., trigger condition) to initiate a monitored workflow. The monitored workflow may include navigating a first program (e.g., user interface 202A) by visually reviewing user interface element two and two point one, activating function of user interface element two (e.g., via user input), visually reviewing user interface element one of sub menu five, and selecting the “OK” button (e.g., indicated by click).

The monitored workflow may continue with operation of a second program (e.g., user interface 202B), by visually reviewing user interface element one and four (e.g., illustrated by second illustrative symbol) of user interface 202B. After which, the user may continue the monitored workflow via operation of a third program (e.g., user interface 202C) by visually reviewing user interface element three of user interface 202C, user interface element one, two, three, and six of sub menu seven, and selecting “OK” to complete the monitored workflow.

By generating a logical attention map during performance of a workflow using eye tracking data and user input, the attention of the user may be inferred. The inferred attention of the user may be used to identify an interaction of the user with the user interface elements and generate a first string representing the user interface element and a second string representing the interaction. The second string may uniquely identify the interaction and/or an outcome of the interaction. The first string and the second string may be concatenated (e.g., combined) to obtain a third string representing the interactions of the user with the user interface elements corresponding to a temporal order in which the interactions occurred.

The representation of interactions between the user and the user interface elements may be used to update operation of data processing system 100. For example, a user experience designer may use the information to reconfigure the design of an application. The improvements in downstream use (e.g., usability) may allow for improved remediation of future failures of data processing systems, thereby improving the reliability and/or accessibility to computer-implemented services provided by the data processing systems.

Turning to FIG. 2E, a second example illustration of interactions between a user and user interface elements (presented by a data processing system) during performance of a monitored workflow. The monitored workflow illustrated in FIG. 2E may be similar to the monitored workflow performed in FIG. 2D.

In FIG. 2E, user interfaces (e.g., 202A, 202B, 202C) may be similar to the user interfaces shown in FIG. 2D and various symbols (e.g., 250, 252, 256, etc.) used to indicate interactions with interface elements within various user interfaces by a user may be similar to those illustrated and described above in FIG. 2D. For example, the symbols may include a first illustrative symbol 252, which represents using a pointing device to click on a graphical user interface element. For example, a user may operate a computer mouse to navigate the pointing device (e.g., cursor) displayed on the user interface element and provide user input (e.g., user input data 206 shown in FIG. 2A).

In addition, the illustrative symbols (e.g., 254 and/or 258) may indicate an outcome of the interaction (e.g., whether the interaction lead to a desired outcome for the user). For example, illustrative symbol 254 may represent a failure regarding the outcome of the interaction (e.g., determination that the interaction lead to an undesired outcome for the user). The undesired outcome may indicate, for example, a failure to perform a function as intended by the user and therefore hindering the ability of the user to perform the next interaction that leads to (and/or eventually leads to) completion of the monitored workflow.

For example, the line drawn in dashing between the interaction of the user's gaze (e.g., indicated by the interaction 250 at user interface 202B) at user interface element one of user interface 202B and the user's gaze at user interface element three of user interface 202C may indicate the visual pathway travelled by the eye's of the user. The pathway between the interactions may be labelled as a failed outcome (e.g., illustrated by 254) as a result of the interactions lead to an undesired outcome for the user (e.g., failing to perform a function to move to the next interaction, not providing necessary information to reach the defined end of the monitored workflow, etc.).

The illustrative symbol 258 may represent a success regarding the outcome of the interaction (e.g., determination that the interaction lead to a desired outcome for the user). The desired outcome may indicate, for example, a success to perform a function as intended by the user and therefore allowing the user to perform the next interaction that leads to (and/or eventually leads to) completion of the monitored workflow.

For example, the line drawn in a dash separated by a dot illustrated between the interaction of the user input (e.g., 252 selecting “OK”) and the user's gaze at user interface element four of user interface 202B may indicate the pathway travelled between the two interactions. The pathway between the interactions may be labelled as a successful outcome (e.g., illustrated by 258) as a result of the interactions leading to a desired outcome for the user (e.g., successfully performing a function to move to the next interaction, providing the necessary information to reach the defined end of the monitored workflow, etc.).

To obtain metadata for the user flow data set (e.g., series of interactions shown in FIG. 2E) may include analyzing each interaction of the set of interactions. For example, each interaction may be counted and for each counted interaction, the type of interaction (e.g., user input, eye gaze, etc.), the transition cost between the two interactions, identifying whether the interaction lead to a desired outcome of the interaction, and/or any other information may be identified and used to generate an estimated duration of time to complete the monitored workflow.

To obtain clear quantifications of how users interaction with user interface elements during performance on a monitored workflow, a standardized method of scoring each user flow data set may be implemented by using predefined estimates for each quantification that contributes to the performance of the monitored workflow. The predefined estimates for each quantification may be established, for example, by a subject matter expert. For example, time estimates to each user interaction may be assigned based on predefined expert evaluations (e.g., 0.5 seconds, 1.5 seconds, etc.), to measure user time cost. Different types of user interactions (e.g., eye movements, mouse clicks, etc.) may have distinct expect time costs, where certain actions (e.g., like eye movements) might be faster.

The transition cost between two interactions (e.g., interaction 1 and 2) may include measuring the time it takes to move between different interactions, influenced by the distance between the view blocks (e.g., different user interface elements) during performance of the monitored workflow in a prescribed manner by the user. For example, the transition cost between interaction 1 and interaction 2 may be estimated by performing a function that identifies a weight to the time elapsed between the interactions.

By obtaining the metadata for the user flow data set, the user flow data set may be compared to other user flow data sets for other instances of performing the monitored workflow in order to obtain an ordering of the user flow data sets. The user flow data set represented in FIG. 2E may be compared to the user flow data set represented in FIG. 2D and the outcome may indicate the user flow data set shown in FIG. 2D has a lower user time cost (e.g., lower weighted sum) than the user flow data set shown in FIG. 2E. As a result, the metadata indicating quantifications impacting the user time cost may be analyzed to identify modifications and/or updates to the user interface elements that may be implemented for improving user interactions. Thereby, improving the likelihood of performing the monitored workflow in a desired manner and the computer implemented services being provided may be increased.

Turning to FIG. 2F, a third example illustration of interactions between a user and user interface elements (presented by a data processing system) during performance of a monitored workflow. The monitored workflow illustrated in FIG. 2F may be similar to the monitored workflow performed in FIG. 2D.

As described above, a user flow data set for an instance of performing a monitored workflow may be identified for simplification. The user flow data set may be identified, for example, by selecting the highest ranked user flow data set based on an ordering of user flow data sets (e.g., obtained for a plurality of instances of performing the monitored workflow).

Once identified, the user flow data set may be analyzed to obtain a recommendation (also referred herein as simplification recommendation) for modifying a user interface used by a user during performance of the monitored workflow. To obtain the (at least one) simplification recommendation, the user flow data set (e.g., more specifically the discretized textual representation of the instance of performing the monitored workflow stored in the user flow data set) may be subjected to an automated analysis process.

Although a graphical representation of the user flow data set is shown in FIG. 2F, it may be understood that the automated analysis may be performed using the discretized textual representation of the instance of the performance of the monitored workflow (e.g., stored in the user flow data set) in order to obtain at least one simplification recommendation.

During the automated analysis process, the frequency of use for each user interface and user interface elements of the user interfaces may be compared against predefined criteria to evaluate their relevance to the monitored workflow. The criteria may include, for example, a minimum threshold for the number of interactions required for a user interface to be considered essential (e.g., to performing the monitored workflow in predefined manner).

For example, the automated analysis may include: (i) identifying various user interfaces used by a user during the instance of performing the monitored workflow, (ii) identifying the numbers of uses of interface elements in each of the various user interfaces, (iii) comparing the number of uses and user interfaces to criteria to identify (at least one of) the various user interfaces for removal from future instances of the performance of the monitored workflow, and/or (iv) obtaining the (at least one) simplification recommendation based on the identified user interfaces for removal.

The criteria may specify a maximum number of user interfaces that are to be used in performing the monitored workflow (in the future) and the (at least one) of the various user interfaces may be selected due to the criteria not being met. The user interfaces and/or interface elements of each user interface that do not meet the criteria may be identified (e.g., flagged, selected, etc.) for potential removal from future iterations of the monitored workflow.

For example, the criteria for the monitored workflow illustrated in FIG. 2F may specify two user interfaces is the maximum user interfaces that are to be used during performing the monitored workflow and at least three interactions are required for each user interface for the user interface to be considered relevant in performance of the monitored workflow. For example, based on this criteria, user interface 202B may be identified as a user interface for removal from future instances of performing the monitored workflow since user interface 202B was only interacted with twice by a user (e.g., eye gaze of the user at user interface element one and user interface element four) during performance of the monitored workflow.

Based on the identified user interfaces for removal, a portion of interface elements may be selected and a recommendation to move the selected portion of the interface elements from the user interfaces identified for removal to other user interfaces used by the user during future performance of the monitored workflow. For example, the simplification recommendation may include moving user interface elements one and four of user interface 202B to user interface 202C as represented by individual arrows directed from each eye gaze interaction (e.g., illustrative symbol 250) with user interface elements one and four pointed to user interface 202C.

Another simplification recommendation may include reordering interface elements to reduce spatial distances between the interface elements interacted with by a user during performance of the monitored workflow. As an additional example, during the automated analysis process, the spatial distances between the interface elements of the user interfaces may be compared against predefined criteria to evaluate whether the distance between two or more interface elements is too large, and therefore, potentially affecting the efficiency in performing the monitored workflow. The criteria may include, for example, a maximum distance threshold that discriminates the interface elements for reordering within the user interface.

For example, the automated analysis may include: (i) identifying interface elements in each user interface of the user interfaces used by the user during performance of the monitored workflow, (ii) identifying spatial distances between the interface elements in each of the user interfaces, (iii) comparing the spatial distances to criteria to identify (at least one of) the interface elements for reordering within a user interface for future instances of the performance of the monitored workflow, and/or (iv) obtaining the (at least one) simplification recommendation based on the identified interface elements for reordering.

For example, the criteria for the monitored workflow illustrated in FIG. 2F may define 400 pixels is the maximum distance between interface elements used during performance of the monitored workflow. Based on this criteria, if the distance between user interface element one and user interface element four on user interface 202B exceeds the threshold (e.g., more than 400 pixels), at least one of the user interface elements (e.g., user interface element one and/or user interface element four) may be identified for reordering within the user interface.

Based on the identified (at least one of) the interface elements, a portion of the user interface elements may be selected and a recommendation to reorder the selected portion of the user interface elements within the user interface may be made. For example, the simplification recommendation may include repositioning user interface elements one and four of user interface 202B to be closer to each other (e.g., at least meet the maximum distance criteria). For example, the user interface elements one and four of user interface 202B may be reordered within user interface 202C and represented as user interface elements eight and nine, respectively.

For example, turning to FIG. 2G, a diagram illustrating a portion of the user flow data set show in FIG. 2D modified based on simplification recommendation obtained in FIG. 2F. As illustrated and/or described in FIG. 2F, the simplification recommendation may be obtained via performance of an automated analysis process. Once the simplification recommendation is obtained, modifications to the user interfaces used by the user during performance of a monitored workflow may be made based at least in part on the simplification recommendation.

For example, the simplification recommendation illustrated in FIG. 2F may include (i) moving a selected portion of the interface elements from user interfaces identified for removal from future instances of the performance of the monitored workflow to other user interfaces used by the user during future instances of the performance of the monitored workflow and/or (ii) reordering interface elements in each user interface used by the user during performance of the monitored workflow. For example, the previously labeled user interface elements one and four of user interface 202B may be moved to user interface 202C and reordered to reduce the spatial distance between the user interface elements represented as user interface elements eight and nine, respectively.

By moving the user interface elements one and four from user interface 202B to user interface 202C, the user interface elements interacted with (by a user) to perform the monitored workflow may be consolidated and the amount of user interfaces used by the user during performance of the monitored workflow would be reduced. By reordering the interface elements (now labeled as interface elements eight and nine) within user interface 202C, the distance between interface elements interacted with (by the user) to perform the monitored workflow may be reduced. By doing so, unnecessary navigation and/or scrolling of the user interfaces and/or interface elements by a user may be reduced and therefore, the time required to perform the monitored workflow may be reduced.

As discussed above, the components of FIGS. 1-2G may perform various methods to manage operations of data processing systems during performance of various workflows based at least in part on simplification recommendation(s) obtained during automated analysis of user flow data set. A discretized textual representation of the instance of performing the monitored workflow may be stored in the user flow data set and may be subject to any type of analysis processes to identify recommendations for modifying user interfaces (and/or interface elements within each of the user interfaces) used during performance of the monitored workflow. By obtaining at least one simplification recommendation, operation of the user interface used by a data processing system may be updated and therefore, the monitored workflow may be optimized by eliminating unnecessary user interfaces, reordering user interface elements within each user interfaces and the operational complexity may be reduced.

FIG. 3 illustrates a method that may be performed by the components of the system of FIGS. 1-2G. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system and/or another device.

Turning to FIG. 3, a flow diagram illustrating a method of managing a data processing system in accordance with an embodiment is shown. The method may be performed, for example, by a data processing system, a management system, a communication system, hardware resources, and/or other components illustrated in FIGS. 1-2G.

At operation 300, a user flow data set for an instance of a performance of a monitored workflow for simplification may be identified. The user flow data set may be based on eye tracking of a user and user input by the use during the instance of the performance of the monitored workflow.

The user flow data set may be identified by (i) obtaining an ordering of user flow data sets for a plurality of instances of performance of the monitored workflow, (ii) selecting the highest ranked user flow data set of ranked user flow data sets, and/or (iii) by any other methods.

The ordering of the user flow data sets may be obtained by (i) obtaining, for each user flow data set of the user flow data sets, metadata comprising at least one quantification usable to order the user flow data sets, (ii) estimating a user time cost based on a portion of the metadata corresponding to the respective user flow data set of the user flow data sets, and/or (iii) ordering the user flow data sets based on the corresponding user time costs.

Obtaining the metadata may include: for a user flow data set of the user flow data sets: counting a number of the interactions that the user performed to complete a corresponding instance of the plurality of instances of the performance of the monitored workflow to obtain an interaction count. For example, the metadata may be obtained by performing any type of function that calculates the number of interactions that the user performed during the monitored workflow. For instance the function may identify, for each eye tracking data and/or user input received between the user and user interface element, a interaction and count that interaction as part of a series of interactions of the user flow data set.

Obtaining the metadata may also include: for the user flow data set of the user flow data sets: for each of the number of interactions: estimating a transition cost for transitioning between two of the number of interactions. For example, estimating the transition cost may include performing a function that identifies a weight to the time elapsed between two interactions (e.g., a first interaction and a second interaction) of the user flow data sets.

Obtaining the metadata may also include: for the user flow data set of the user flow data sets: for each of the number of interactions: identifying whether the respective interaction of the number of interactions lead to a desired outcome for the user. For example, identifying whether the interaction lead to a desired outcome for the user may be facilitated by (i) reading metadata indicating the desired outcome of the interaction, (ii) identifying outcome of the interaction lead to completion of the monitored workflow, and/or (iii) by performing any other methods.

Obtaining the metadata may also include: for the user flow data set of the user flow data sets: for each of the number of interactions: identifying a type of the respective interaction of the number of interactions. For example, the type of interaction may be identified based on reading the metadata indicating the type of interaction (e.g., user input, eye gaze of a user, etc.).

The user time cost for each of the user flow data sets may be estimated based on a portion of the metadata corresponding to the respective user flow data set of the user flow data sets. For example, the user time costs may be estimated using a formula/function that ingests various portions of the metadata and generates a weighted sum based on the portions of the metadata.

The output may be a quantification that indicates an estimated duration of time for completing a corresponding user flow data set (e.g., of the user flow data sets) when performed in a prescribed manner (e.g., as intended) by the user.

The user flow data sets may be ordered based on the corresponding user time costs. For example, the user time costs for each of the user flow data sets may be compared to one another to set an ordering of highest ranked user flow data set to a lowest ranked user flow data set.

The ordering of the user flow data sets may be a ranking order of the user flow data sets from a lowest user time cost to a highest user time cost. For example, the ranking order of the user flow data sets may indicate the user flow data set with the lowest weighted sum for the user time cost to be the highest ranked user flow data set and the user flow data set with the highest weighted sum to be the lowest ranked user flow data set (e.g., of the plurality of instances of performing the monitored workflow).

At operation 302, at least one simplification recommendation for modifying an instance of a user interface used by the user during the instance of the performance of the monitored workflow may be obtained through automated analysis of a discretized textual representation of the instance of the performance stored in the user flow data set.

Obtaining the at least one simplification recommendation may include: (i) identifying, using the discretized textual representation of the instance of the performance stored in the user flow data set, a plurality of user interfaces used by the user during the instance of the performance; (ii) identifying, using the discretized textual representation of the instance of the performance stored in the user flow data set, numbers of uses of interface elements in each of the plurality of user interfaces by the user during the instance of the performance; (iii) comparing the number of uses and the plurality of user interfaces to criteria to identify at least one of the plurality of user interfaces for removal from future instances of the performance; and/or (iv) obtaining the at least one simplification recommendation based on the at least one of the plurality of user interfaces for removal from the future instances of the performance.

Obtaining the at least one simplification recommendation may further include: (i) selecting a portion of the interface elements based on the at least one of the plurality of user interfaces; and/or (ii) generating a recommendation to move the selected portion of the interface elements from the at least one of the plurality of user interfaces to other user interfaces used by the user during future instances of the performance.

Obtaining the at least one simplification recommendation may also include: (i) identifying, using the discretized textual representation of the instance of the performance stored in the user flow data set, interface elements in each user interface of a plurality of user interfaces used by the user during the instance of the performance; (ii) identifying, using the discretized textual representation of the instance of the performance stored in the user flow data set, spatial distances between the interface elements in each of the plurality of user interfaces during the instance of the performance; (iii) comparing the spatial distances to criteria to identify at least one of the interface elements for reordering within a user interface of the user interfaces for future instances of the performance; and/or (iv) obtaining the at least one simplification recommendation based on the at least one of the interface elements for reordering within the user interface for the future instances of the performance.

At operation 304, operation of the instance of the user interface used by the data processing system may be updated based at least in part on the at least one simplification recommendation to obtain an updated data processing system. The operation may be updated by: (i) providing the at least one simplification recommendation to an external entity to implement updates to the data processing system, (ii) implement modifications to operation of the user interface based on at least the one simplification recommendation, and/or (iii) by performing any other methods. The updates may modify hardware/software/configurations/etc. of the monitored workflow, may result in changes to the user interface elements interacted with by a user during performance of the monitored workflow, etc.

At operation 306, computer implemented services are provided using the updated data processing system. The computer implemented services may be any type and quantity of such services. The computer implemented services may be provided by implementing the updates to the data processing system when operated by a user (e.g., interacting with the updated data processing system).

The method may end following operation 306.

Using the methods illustrated in FIG. 3, embodiments disclosed herein may provide systems and methods usable to manage operations of data processing systems by analyzing user flow data sets for performances of monitored workflows. By analyzing user flow data sets based on metadata regarding variables impacting duration of time and/or outcome of interactions during the user flow data sets, an ordering of the user flow data sets may be obtained and used to update operation of the data processing system. By updating operation of the data processing system using the ordered user flow data sets, desired computer implemented services may be more likely to be provided to a user of the updated data processing system.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
identifying a user flow data set for an instance of a performance of a monitored workflow for simplification, the user flow data set being based on eye tracking of a user and user input by the use during the instance of the performance of the monitored workflow;
obtaining at least one simplification recommendation for modifying an instance of a user interface used by the user during the instance of the performance of the monitored workflow through automated analysis of a discretized textual representation of the instance of the performance stored in the user flow data set;
updating, based at least in part on the at least one simplification recommendation, operation of the instance of the user interface used by the data processing system to obtain an updated data processing system; and
providing computer implemented services using the updated data processing system.

2. The method of claim 1, wherein the user flow data set is selected from an ordering of user flow data sets for a plurality of instances of performance of the monitored workflow, and the selected user flow data set being the highest ranked user flow data set of ranked user flow data sets.

3. The method of claim 2, wherein the ordering of the user flow data sets is obtained by:
for each user flow data set of the user flow data sets:
obtaining, for each user flow data set of the user flow data sets, metadata, the metadata comprising at least one quantification usable to order the user flow data sets;
estimating a user time cost based on a portion of the metadata corresponding to the respective user flow data set of the user flow data sets; and
ordering the user flow data sets based on the corresponding user time costs.

4. The method of claim 2, wherein obtaining the metadata comprises:
for each user flow data set of the user flow data sets:
counting a number of interactions performed to complete the corresponding instance of performance of the monitored workflow to obtain an interaction count;
for each of the number of interactions:
estimating a transition cost for transitioning between two of the number of interactions;
identifying whether the respective interaction of the number of interactions lead to a desired outcome for the user; and
identifying a type of the respective interaction of the number of interactions.

5. The method of claim 1, wherein obtaining the at least one simplification recommendation comprises:
identifying, using the discretized textual representation of the instance of the performance stored in the user flow data set, a plurality of user interfaces used by the user during the instance of the performance;
identifying, using the discretized textual representation of the instance of the performance stored in the user flow data set, numbers of uses of interface elements in each of the plurality of user interfaces by the user during the instance of the performance;
comparing the number of uses and the plurality of user interfaces to criteria to identify at least one of the plurality of user interfaces for removal from future instances of the performance; and
obtaining the at least one simplification recommendation based on the at least one of the plurality of user interfaces for removal from the future instances of the performance.

6. The method of claim 5, wherein the criteria comprises a minimum number of uses threshold that discriminates the at least one of the plurality of user interfaces for removal.

7. The method of claim 5, wherein obtaining the at least one simplification recommendation comprises:
selecting a portion of the interface elements based on the at least one of the plurality of user interfaces; and
generating a recommendation to move the selected portion of the interface elements from the at least one of the plurality of user interfaces to other user interfaces used by the user during future instances of the performance.

8. The method of claim 5, wherein the criteria specifies a maximum number of user interfaces that are to be used in future instances of the performance, and the at least one of the plurality of user interfaces is selected due to the criteria not being met.

9. The method of claim 1, wherein obtaining the at least one simplification recommendation comprises:
identifying, using the discretized textual representation of the instance of the performance stored in the user flow data set, interface elements in each user interface of a plurality of user interfaces used by the user during the instance of the performance;
identifying, using the discretized textual representation of the instance of the performance stored in the user flow data set, spatial distances between the interface elements in each of the plurality of user interfaces during the instance of the performance;
comparing the spatial distances to criteria to identify at least one of the interface elements for reordering within a user interface of the user interfaces for future instances of the performance; and
obtaining the at least one simplification recommendation based on the at least one of the interface elements for reordering within the user interface for the future instances of the performance.

10. The method of claim 9, wherein the criteria comprises a maximum distance threshold that discriminates the at least one of the interface elements for reordering within the user interface.

11. The method of claim 9, wherein the criteria specifies a minimum spatial distance between interface elements in future instances of the performance, and the at least one of the interface elements is selected due to the criteria not being met.

12. A non-transitory machine-readable medium having instructions stored therein, which when executed by a processor, cause the processor to perform operations for managing operation of a data processing system, the operations comprising:
identifying a user flow data set for an instance of a performance of a monitored workflow for simplification, the user flow data set being based on eye tracking of a user and user input by the use during the instance of the performance of the monitored workflow;
obtaining at least one simplification recommendation for modifying an instance of a user interface used by the user during the instance of the performance of the monitored workflow through automated analysis of a discretized textual representation of the instance of the performance stored in the user flow data set;
updating, based at least in part on the at least one simplification recommendation, operation of the instance of the user interface used by the data processing system to obtain an updated data processing system; and
providing computer implemented services using the updated data processing system.

13. The non-transitory machine-readable medium of claim 12, wherein obtaining the at least one simplification recommendation comprises:
identifying, using the discretized textual representation of the instance of the performance stored in the user flow data set, a plurality of user interfaces used by the user during the instance of the performance;
identifying, using the discretized textual representation of the instance of the performance stored in the user flow data set, numbers of uses of interface elements in each of the plurality of user interfaces by the user during the instance of the performance;
comparing the number of uses and the plurality of user interfaces to criteria to identify at least one of the plurality of user interfaces for removal from future instances of the performance; and
obtaining the at least one simplification recommendation based on the at least one of the plurality of user interfaces for removal from the future instances of the performance.

14. The non-transitory machine-readable medium of claim 13, wherein the criteria comprises a minimum number of uses threshold that discriminates the at least one of the plurality of user interfaces for removal.

15. The non-transitory machine-readable medium of claim 13, wherein obtaining the at least one simplification recommendation comprises:
selecting a portion of the interface elements based on the at least one of the plurality of user interfaces; and
generating a recommendation to move the selected portion of the interface elements from the at least one of the plurality of user interfaces to other user interfaces used by the user during future instances of the performance.

16. The non-transitory machine-readable medium of claim 13, wherein the criteria specifies a maximum number of user interfaces that are to be used in future instances of the performance, and the at least one of the plurality of user interfaces is selected due to the criteria not being met.

17. The non-transitory machine-readable medium of claim 12, wherein obtaining the at least one simplification recommendation comprises:
identifying, using the discretized textual representation of the instance of the performance stored in the user flow data set, interface elements in each user interface of a plurality of user interfaces used by the user during the instance of the performance;
identifying, using the discretized textual representation of the instance of the performance stored in the user flow data set, spatial distances between the interface elements in each of the plurality of user interfaces during the instance of the performance;
comparing the spatial distances to criteria to identify at least one of the interface elements for reordering within a user interface of the user interfaces for future instances of the performance; and
obtaining the at least one simplification recommendation based on the at least one of the interface elements for reordering within the user interface for the future instances of the performance.

18. A data processing system, comprising:
a processor; and
a memory coupled to the processor to store instructions, which when executed by the processor, cause the processor to perform operations for managing operation of the data processing system, the operations comprising:
identifying a user flow data set for an instance of a performance of a monitored workflow for simplification, the user flow data set being based on eye tracking of a user and user input by the use during the instance of the performance of the monitored workflow;
obtaining at least one simplification recommendation for modifying an instance of a user interface used by the user during the instance of the performance of the monitored workflow through automated analysis of a discretized textual representation of the instance of the performance stored in the user flow data set;
updating, based at least in part on the at least one simplification recommendation, operation of the instance of the user interface used by the data processing system to obtain an updated data processing system; and
providing computer implemented services using the updated data processing system.

19. The data processing system of claim 18, wherein obtaining the at least one simplification recommendation comprises:
identifying, using the discretized textual representation of the instance of the performance stored in the user flow data set, a plurality of user interfaces used by the user during the instance of the performance;
identifying, using the discretized textual representation of the instance of the performance stored in the user flow data set, numbers of uses of interface elements in each of the plurality of user interfaces by the user during the instance of the performance;
comparing the number of uses and the plurality of user interfaces to criteria to identify at least one of the plurality of user interfaces for removal from future instances of the performance; and
obtaining the at least one simplification recommendation based on the at least one of the plurality of user interfaces for removal from the future instances of the performance.

20. The data processing system of claim 19, wherein the criteria comprises a minimum number of uses threshold that discriminates the at least one of the plurality of user interfaces for removal.
